(19) United States
(12) Patent Application Publication
(10) Pub. No.: US 2009/0266736 A1
(43) Pub. Date: Oct. 29, 2009

(54) CONTAINER HAVING AN IDENTIFICATION DEVICE MOLDED THEREIN AND METHOD OF MAKING SAME

(75) Inventors: Gregory SPRISHEN, Newtown Square, PA (US); Lawrence J. BARRESI, Vineland, NJ (US)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: DRUG PLASTICS & GLASS COMPANY, INC., Boyertown, PA (US)

(21) Appl. No.: 12/416,540

(22) Filed: Apr. 1, 2009

Related U.S. Application Data
(60) Provisional application No. 61/047,952, filed on Apr. 25, 2008.

(51) Int. Cl. B65D 25/00; B29C 49/00

(52) U.S. Cl. 206/459.5; 264/523

(57) ABSTRACT

A blow molded container includes an identification device at least partially embedded in a wall of the container. The container has a bottom wall having a periphery and a concave shape that extends generally inwardly into the container and a sidewall surrounding the bottom wall and extending generally upwardly from the periphery. A capsule is at least partially embedded in one of the bottom wall and the sidewall and an identification device is completely enclosed within the capsule. An entire exterior surface of the capsule is surrounded by one of the bottom wall and the sidewall of the container.

### CROSS-REFERENCE TO RELATED APPLICATIONS

The present application claims the benefit of U.S. Provisional Patent Application No. 61/047,952, filed Apr. 25, 2008 and entitled “Automatic Identification Device Molded into a Bottle.”

### BACKGROUND OF THE INVENTION

The present invention relates to the incorporation of an identification device within a package or container for quickly and efficiently identifying the contents of the package or container and, more particularly, to embedding a radio frequency identification (RFID) tag at least partially within a wall of a container.

Pharmaceutical or medical containers for storing, transporting or selling pharmaceutical or medical products are generally well-known. Such containers, bottles or packages are preferably formed of a high strength, lightweight material and are sized and shaped to be easily transported either individually or in a larger container, such as a box. Such containers typically include a removable cap. Generally, the caps are removed from the container by a twisting motion. Further, certain containers may include child-resistant caps that require a specific twisting function to remove the cap from the top of the container.

The process of preparing containers of medicaments for shipment to an end user typically includes the steps of: (1) paper labeling the container with the contents of the container and other information related to the manufacturing history, (2) sealing the end of the container with the cap, and (3) filling the container with a medicament.

The containers are typically included in a larger package to transport the containers and are then individually placed on a shelf in a retail store for selling the product. Although such containers can hold a plurality of different types of pharmaceutical or medical products, the general appearance of the containers is often similar. Due to this similarity, it may be difficult to identify the contents of the container without opening the container to find out what is inside.

It is of the utmost importance that the information on the paper labeling of each container corresponds to the actual contents of the container and includes such information that allows for traceability to the history of manufacture. Thus, information should ideally be associated with each filled container from near the moment that the container is filled.

Presently, however, it is not possible to include with each container at the time of filling, all of the required information on container contents and manufacturing, since paper labeling applied to the container at the time of filling does not always survive the manufacturing and shipping process, and there is sometimes insufficient room on the label to include all of the required information. Further, the destination for each filled container is not known at the time the container is filled. Since the minimum information to be applied to a paper label is generally prescribed by law, and such laws vary from country to country, the paper labeling of containers often cannot be done until the destination of a particular lot of containers is determined.

A further problem associated with labeling of the containers is one of counterfeiting. Counterfeiting may utilize packaging and paper labeling identical to the legitimate articles such that even an experienced end user, such as a pharmacist or medical practitioner, cannot distinguish the counterfeit article from the legitimate article.

Automatic identification technology, which increases business efficiency, reduces data-entry errors and frees-up staff to perform other functions, is generally well-known. Automatic identification is a broad term given to a host of technologies that are used to help machines identify objects. The technologies include bar codes, smart cards, voice recognition, biometric technology, optical character recognition and RFID. Specifically, RFID technology uses radio waves to automatically identify objects. By storing product information on a microchip that is attached to an antenna, RFID tags allow a reader to easily and efficiently identify an object and allow for the addition or deletion of label information at any time.

Various prior art devices have attempted to incorporate RFID tags within pharmaceutical containers to avoid the problems described above. Previously, individuals have been discouraged from attempting to mold the RFID tags within the containers because of the high temperature achieved during the molding process often destroys the RFID tag.

Therefore, it would be desirable to include an automatic identification device in pharmaceutical or medical packages or containers such that a user or manufacturer can quickly and efficiently identify the contents of a packaging or container without inspecting the contents of each package or container. Specifically, it would be desirable to include an RFID tag within a pharmaceutical or medical package or container. Further, it would be desirable to mold an RFID tag within a package or container in such a manner that the RFID tag can withstand the high temperatures achieved during the molding process. This would allow for an accurate knowledge of the inventory level by eliminating the discrepancy between an inventory record and a physical inventory and also prevent destruction of the RFID tag. Further, the sources of error of recordation can be prevented or reduced.

### BRIEF SUMMARY OF THE INVENTION

Briefly stated, the present invention is directed to a method of making a blow molded container having an identification device at least partially embedded in a wall of the container. The method comprises the steps of providing a mold and a mold core; forming a preform at least partially around the mold core; mounting a capsule on a wall of the preform, the capsule including an identification device; inserting the molding core, the preform and the capsule into the mold; blow molding the preform and capsule into a container such that the capsule moves toward and engages a wall of the mold and the preform moves toward and at least partially surrounds at least a portion of the capsule.

In another aspect, the present invention is directed to a blow molded container having an identification device at least partially embedded in a wall of the container. The container has a bottom wall having a periphery and a concave shape that extends generally inwardly into the container and a sidewall surrounding the bottom wall and extending generally upwardly from the periphery. A capsule is at least partially embedded in one of the bottom wall and the sidewall and an identification device is completely enclosed within the capsule. An entire exterior surface of the capsule is surrounded by one of the bottom wall and the sidewall of the container.

### BRIEF DESCRIPTION OF THE SEVERAL VIEWS OF THE DRAWINGS

The following detailed description of the invention will be better understood when read in conjunction with the appended drawings. For the purpose of illustrating the invention, there is shown in the drawings an embodiment which is presently preferred. It should be understood, however, that the invention is not limited to the precise arrangements and instrumentalities shown.

In the drawings:

FIG. 1 is a front perspective view of a preferred embodiment of a container into which an identification device is molded in accordance with the present invention;

FIG. 2A is a top plan view of the container shown in FIG. 1;

FIG. 2B is a cross-sectional elevation view of the identification device molded into the container shown in FIG. 1, taken along line A-A of FIG. 2A;

FIG. 2C is an enlarged fragmentary view of the automatic identification device molded into the container in FIG. 1, taken from area “C” of FIG. 2B;

FIG. 3 is a cross-sectional view of a portion of an injection blow mold for molding an automatic identification device into a container in accordance with the present invention; and

FIG. 4 is a cross-sectional view of a portion of an injection blow mold having a spacer and a vacuum line in accordance with the present invention.

### DETAILED DESCRIPTION OF THE INVENTION

Certain terminology is used in the following description for convenience only and is not limiting. The words “right,” “left,” “lower” and “upper” designate directions in the drawings to which reference is made. The words “inwardly” and “outwardly” refer to directions toward and away from, respectively, the geometric center of the container in accordance with the present invention, and designated parts thereof. Additionally, the term “a,” as used in the specification, means “at least one.” The terminology includes the words noted above, derivatives thereof and words of similar import.

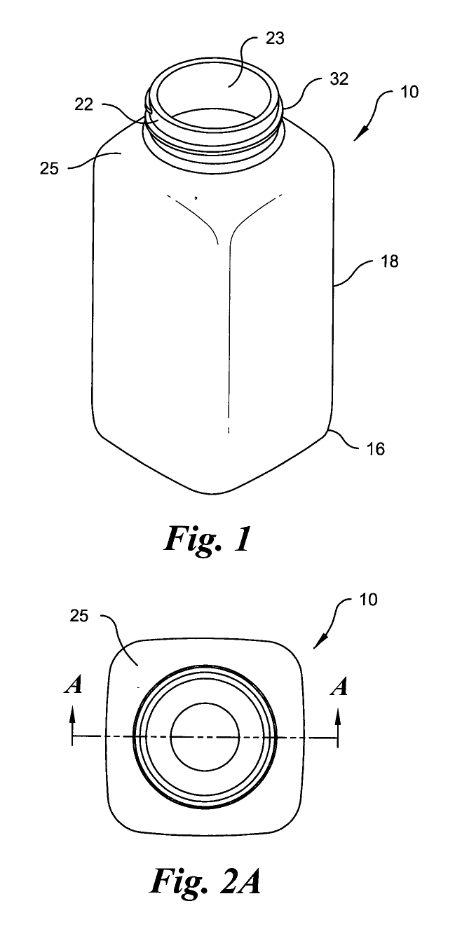

FIGS. 1-4 depict a container, generally designated 10, for storing, transporting or selling a product, such as a pharmaceutical or medical product. The container 10 comprises a bottom wall 14 having a periphery 16 and a concave shape that extends generally inwardly and/or upwardly into the interior of the container 10. The container 10 also includes a sidewall 18 which surrounds the bottom wall 14 and extends generally upwardly from the periphery 16. While is preferred that the container bottom 14 has a generally concave shape, the bottom wall 14 may be generally planar or flat or may be convex, for example. However, it is understood by those of ordinary skill in the art that the container 10 can be in virtually any form, shape or size without departing from the spirit and scope of the present invention. As will be described in greater detail below, the container 10 is preferably formed by a molding process, such as injection blow molding.

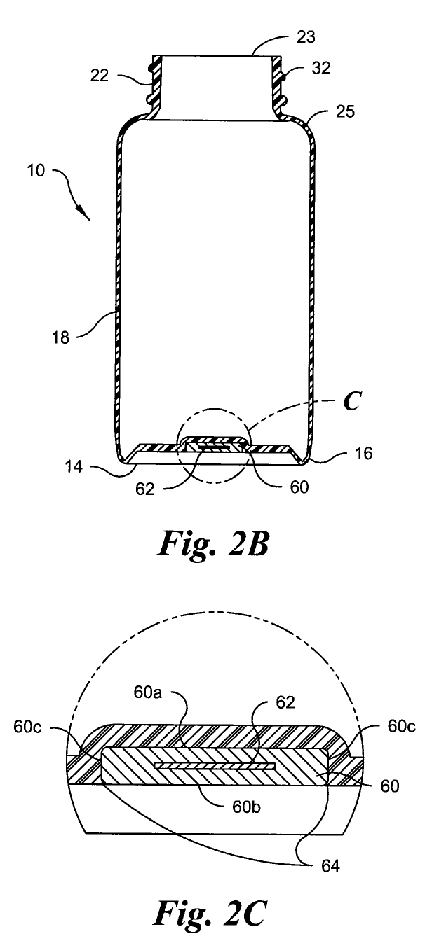

As seen in FIGS. 1 and 2B, the periphery 16 of the bottom wall 14 may be slightly rounded to eliminate sharp edges from the container 10. Preferably, the bottom wall 14 and the sidewall 18 define the container 10 which is generally square in cross-section, although the container 10 may be of any shape, such as a generally rectangular or annular in cross-section, for example. Further, it is understood by those skilled in the art that the form and shape of the container 10 can be modified without departing from the spirit and scope of the present invention. For example, the container 10 can be in the form of virtually any shape, such as a vial, vase or any other such packaging or container, without departing from the spirit and the scope of the invention. The container 10 is preferably formed of a polymeric material, but it is understood by those skilled in the art that the container 10 may be formed of virtually any high-strength, lightweight moldable material.

As shown in FIGS. 1 and 2B, the sidewall 18 of the container preferably includes a neck portion 22 defining an opening 23 for receiving the product. Preferably, the opening 23 in the neck portion 22 is generally circular in cross-section and has a diameter which is smaller than the inner diameter of the sidewall 18. The neck portion 22 may include a transition surface, or shoulder 25, between the neck portion 22 and the sidewall 18. The shoulder 25 is preferably curved to eliminate sharp edges and increase structural integrity. The neck portion 22 may include exterior threads 32 for receiving and retaining a cap (not shown). One of ordinary skill in the art would understand that other means besides threads 32 may be used to accommodate the cap, such as a friction fit or a child-proof fastener (not shown). Further, the container 10 of the present invention is not limited to the inclusion of a cap.

In reference to FIGS. 2B and 2C, an identification device, such as an RFID tag 62 or transponder, is preferably completely enclosed within a capsule 60. RFID tags 62 are generally well known in the art as a method of identification by storing and remotely retrieving data. In the preferred embodiment, the RFID tag 62 contains a silicone chip (not shown) and an antenna (not shown). However, it is understood by those skilled in the art that any form of automatic identification can be used in the present invention without departing from the spirit and scope of the invention.

Referring specifically to FIG. 2C, the capsule 60 preferably includes an exterior surface formed of a generally planar first, top or interior surface 60a and an opposing generally planar second, bottom or exterior surface 60b. The first surface 60a preferably extends generally parallel to the second surface 60b and the first and second surfaces 60a, 60b are spaced a predetermined distance apart by a sidewall 60c that extends generally perpendicularly from the first and second surfaces 60a, 60b around the entire capsule 60. An intersection of the sidewall 60c with each of said first and second surfaces 60a, 60b is preferably arcuate in shape.

Furthermore, the capsule 60 is preferably formed of a high strength generally rigid material, such as a polymeric or ceramic material, and the RFID tag 62 is preferably completely encased therein. However, it is understood by those skilled in the art that the capsule 60 may be formed of virtually any material that can withstand the high temperatures of the molding process while protecting the RFID tag 62. Once the production process is complete, as described in further detail below, the capsule 60 is preferably secured and/or completely enclosed or surrounded within the bottom wall 14 of the container 10 by portions of a perform 42 that forms undercuts 64 below the capsule 60 for retaining the capsule 60 in the bottom wall 14.

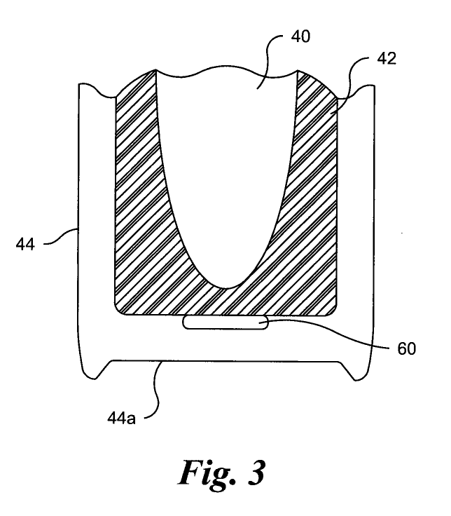

In production, as is shown in FIG. 3, a manufacturer preferably forms the container 10 and integral and/or embedded automatic identification device through a molding process. Specifically, the manufacturer creates the preform 42 such that a “skin” is developed. Before the preform 42 is transferred to the molding core 40, the capsule 60 enclosing the RFID tag 62 is attached and/or mounted to the end of the preform 42. The combined preform 42 and capsule 60 are then transferred to the molding core 40. A media, such as an epoxy, is preferably used to secure the capsule 60 to the end of the preform 42. It is understood by those of ordinary skill in the art that virtually any method of securing the capsule 60 to the preform 42 may be used without departing from the spirit and scope of the present invention.

Next, the molding core 40, the preform 42 and the capsule 60 are inserted into a mold 44, such as an injection blow mold. Specifically, as air is inserted or injected into the mold 44, the capsule 60 and preform 42 are forced to move toward and engages the bottom 44a of the mold 44. First, the capsule 60 contacts the bottom 44a of the mold 44 and then the perform 42 contacts the bottom 44a of the mold 44 such that the preform and the mold 44 completely surround the capsule 60. However, it is understood that the capsule 60 may initially be placed on a sidewall of the preform 42 such that the capsule 60 is eventually forced to move toward a sidewall 44b of the mold 44. In this embodiment, the end product would include the capsule 60 that is at least partially, but preferably completed, embedded in a sidewall 18 of the container 10.

As a result of the molding process of the preferred embodiment, the capsule 60 is preferably pinned or fixedly attached to the bottom 44a of the mold 44 just before the container 10 is created. In the preferred embodiment, due to the curvature of a bottom 44a of the mold 44, the preform 42 undercuts 64 the capsule 60 to securely hold the capsule 60 in place. Specifically, the preform 42 completely surrounds the first surface 60a, the sidewall 60c and the arcuate intersection of the sidewall 60c and the second wall 60b such that said preform 42 undercuts at least a portion of the capsule 60 to securely hold the capsule 60 in place. It is understood by those of ordinary skill in the art that the various steps described above of the process used to create the container 10 containing an integral automatic identification device can be preformed in difference sequences without departing from the spirit and scope of the present invention.

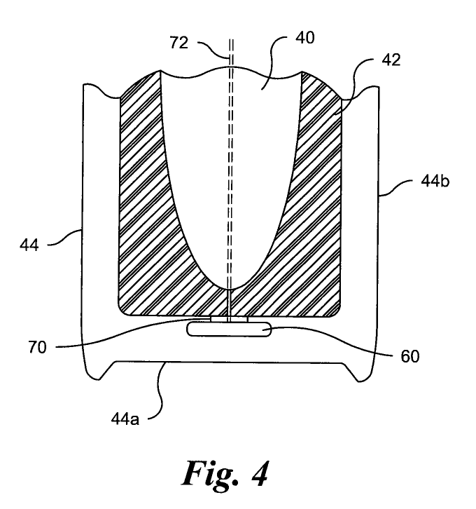

The preform 42 may include a spacer 70, such as a plug push-up, that is securely attached to the preform 42 on one exterior side, end or surface thereof. The spacer 70 preferably is in the form of a small pedestal with a flat area on a side opposite to the side attached to the preform 42. Preferably, the spacer 70 holds the capsule 60 in the proper position when the capsule 60 is secured to the end of the preform 42. The spacer 70 allows for the polymeric material to blow under the capsule 60 enough to keep the capsule 60 locked into the bottom wall 14 or sidewall 18 of the container 10 after it is molded. It is understood by those of ordinary skill in the art that the size and shape of the spacer 70 may be modified without departing from the broad inventive concept thereof. Further, a vacuum line 72 (shown in phantom in FIG. 4) in the center of the spacer 70 may be used to prevent the capsule 60 from relocating itself or being inadvertently moved during the molding of the container 10. Specifically, air may be withdrawn, removed or sucked through the vacuum line 72 to keep the capsule 60 against an end of the preform 42 during the molding process. Those of ordinary skill in the art understand that other types of attachment or centering processes may be used without departing from the spirit and scope of the present invention.

Once molding of the container 10 has been completed and the manufacturer, distributor or consumer desires to know the contents of the container 10, a scanner (not shown) is placed within the general vicinity of the container 10 to read the information stored in the RFID tag 62, which is at least partially but preferably completely embedded in a wall of the container 10. The RFID tag 62 is generally well protected when securely located within the container 10 and capsule 60, as taught by the present invention. A user or manufacturer will also generally know the exact location of the RFID tag 62 when attempting to identify the contents of the outer container 10.

It will be appreciated by those skilled in the art that changes could be made to the embodiments described above without departing from the broad inventive concept thereof. It is understood, therefore, that this invention is not limited to the particular embodiment disclosed but it is intended to cover modifications within the spirit and scope of the present invention as defined by the drawings and specification.

I/We claim:

1. A method of making a blow molded container having an identification device at least partially embedded in a wall of said container, said method comprising the steps of:
(a) providing a mold and a mold core;
(b) forming a preform at least partially around said mold core;
(c) mounting a capsule on a wall of said preform, said capsule including an identification device;
(d) inserting said molding core, said preform and said capsule into said mold;
(e) blow molding said perform and capsule into a container such that said capsule moves toward and engages a wall of said mold and said perform moves toward and at least partially surrounds at least a portion of said capsule.

2. The method according to claim 1 wherein said identification device is a radio frequency identification (RFID) tag.

3. The method according to claim 2 wherein said capsule completely encloses said RFID tag.

4. The method according to claim 3 wherein said capsule is formed of a polymeric material.

5. The method according to claim 2 wherein said container includes a bottom wall and a sidewall extending generally perpendicularly therefrom, said bottom wall having a concave shape that extends generally inwardly into said container, wherein said preform undercuts at least a portion of said capsule following step (e) to securely hold said capsule in place.

6. The method according to claim 2 wherein said capsule includes a generally planar first surface and an opposing generally planar second surface, said first surface extending generally parallel to said second surface, said first and second surfaces being spaced a predetermined distance apart by a sidewall extending generally perpendicularly therefrom around the entire capsule, an intersection of said sidewall with each of said first and second surfaces being arcuate in shape, wherein said preform completely surrounds said first surface, said sidewall and said arcuate intersection of said sidewall and said second surface such that said preform undercuts at least a portion of said capsule following step (e) to securely hold said capsule in place.

7. The method according to claim 2, further including the steps of attaching a spacer to a bottom of said preform following step (b) and then mounting said capsule to said spacer.

8. The method according to claim 7, further including the steps of providing a vacuum line proximate a center of said spacer and removing air from said vacuum line to prevent inadvertent movement of said capsule during blow molding.

9. The method according to claim 1, further including the step of mounting said capsule in a bottom wall of said preform such that said capsule engages a bottom wall of said mold.

10. The method according to claim 1 wherein said preform and said mold completely surround said capsule following step (e).

11. A blow molded container having an identification device at least partially embedded in a wall of said container, said container comprising:
a bottom wall having a periphery and a concave shape that extends generally inwardly into said container;
a sidewall surrounding said bottom wall and extending generally upwardly from said periphery;
a capsule at least partially embedded in one of said bottom wall and said sidewall; and
an identification device completely enclosed within said capsule;
wherein an entire exterior surface of said capsule is surrounded by one of said bottom wall and said sidewall of said container.

12. The container according to claim 11 wherein said identification device is a radio frequency identification (RFID) tag.

13. The container according to claim 12 wherein said capsule is completely embedded in said bottom wall of said container.
